(19) United States
(12) Patent Application Publication
(10) Pub. No.: US 2017/0251861 A1
(43) Pub. Date: Sep. 7, 2017

(54) REUSABLE FILTER CARTRIDGE FOR MULTIPLE BREWER TYPES

(71) Applicant: Eko Brands, LLC, Woodinville, WA (US)

(72) Inventor: Ronald R. DeMiglio, Snohomish, WA (US)

(21) Appl. No.: 15/061,082

(22) Filed: Mar. 4, 2016

(51) Int. Cl. A47J 31/06; A23F 3/18; A47J 31/40; A23F 5/26

(52) U.S. Cl. CPC A47J 31/0689; A23F 5/262; A23F 3/18; A47J 31/0668; A47J 31/407

(57) ABSTRACT

A reusable filter cartridge includes a base cup having a sidewall defining a plurality of openings that are covered with a filtering material. A bottom wall of the base cup defines impermeable outlet probe receptacles sized and positioned to receive an outlet probe of a brewing device. Two or more adapter rings removably secure to the base cup thereby defining multiple combinations with differing volumes for use in different brewing devices and for preparing different numbers of servings. An adapter ring for multiple-serving implementations may include a tube along the side thereof with a bottom opening located below the lowermost surface of the adapter ring. An insert secures within each adapter ring and defines an inlet probe aperture and structures for creating a seal with respect to an inlet probe of a brewing device.

### FIELD OF THE INVENTION

This application relates to cartridges for holding a brewing medium for use with an automated beverage brewer.

### BACKGROUND OF THE INVENTION

There are numerous devices available today for making a single-serve brewed beverage, such as the single-server brewers shown and described in, for example, U.S. Pat. Nos. 6,708,600, and 6,079,315, the disclosures of which are hereby expressly incorporated by reference herein.

In a typical single-serve beverage brewer, a disposable beverage filter cartridge containing a dry beverage medium (such as tea or coffee) is disposed within a filter cartridge holder or brewing holster. To brew the beverage, the filter cartridge is pierced by inlet and outlet probes to accommodate a through-flow of metered hot water. The hot water infuses the dry beverage medium contained in the cartridge to thereby produce a single serving of the beverage. After the beverage is brewed, the cartridge is removed from the cartridge holder and it is discarded.

By requiring the use of the disposable cartridges, the consumer is limited to the beverage selection of the cartridges on hand. Moreover, with each cartridge being disposed of after use, there is much needless waste. Thus there is a need for a reusable cartridge filter suitable for use with a beverage brewer described above that can be used with any desired dry beverage medium (coffee, tea, etc.).

The apparatus and methods disclosed herein provide an improved approach for preparing brewed beverages using a beverage brewer designed to use disposable cartridges.

### SUMMARY OF THE INVENTION

In one aspect of the invention, a method for brewing includes removably fastening a first ring to a base cup, the base cup defining one or more sidewall apertures completely covered with a permeable filter material and an outlet probe receptacle protruding inwardly from a lower surface thereof. The method further includes placing a first quantity of a brewing substance in the first ring and base cup; securing a first lid to the first ring, the first lid defining a first inlet probe aperture; inserting the first ring and base cup into a first cavity of a first beverage brewer having a first outlet probe of the first coffee maker projecting into the outlet probe receptacle; inserting a first inlet probe of the first beverage brewer into the first inlet probe aperture; and brewing a first beverage by inputting liquid through the first inlet probe and drawing liquid out through the first outlet probe.

The method further includes removing the base cup from the first ring and removably fastening the base cup to a second ring, the second ring extending upwardly from the base cup a different extent than the first ring. The method further includes placing a second quantity of the brewing substance in the second ring and base cup; securing a second lid to the second ring, the second ring defining a second inlet probe aperture; inserting the second ring and base cup into a second cavity of a second beverage brewer, the second beverage brewer including a second outlet probe; inserting a second inlet probe of the second beverage brewer into the second inlet probe aperture; and brewing a second beverage by inputting liquid through the second inlet probe and drawing liquid out through a second outlet probe.

In some embodiments, the second ring extends upwardly from the base cup a greater extent than the first ring. For example, the first ring and base cup when fastened to one another define a volume sized for brewing of a single serving. Whereas the second ring and base cup when fastened to one another define a volume sized for brewing three or more servings.

In some embodiments, a tube is fastened along a sidewall of the second ring and the method further includes inserting the second outlet probe into the tube. In some embodiments, the tube extends downwardly beyond a lowermost edge of the second ring. The tube defines a bottom opening that is positioned outside of an interior volume defined by the base cup and second ring.

In some embodiments, the base cup includes base threads, the first ring includes first threads, and the second ring includes second threads. Fastening the first ring to the base cup includes engaging the base threads with the first threads and fastening the second ring to the base cup comprises engaging the base threads with the second threads.

In some embodiments, the outlet probe receptacle is a first outlet probe receptacle, the base cup further defining a second outlet probe receptacle, the first and second outlet probe receptacles being 180 degrees apart. The outlet probe receptacle may define a continuous imperforated surface.

In some embodiments, the first and second lids further include a resilient material and defines a recess on an upper surface of the lid surrounding the inlet probe aperture, the recess sized to receive a shoulder surrounding an inlet probe.

In another aspect of the invention a beverage brewing device is disclosed for use with both (i) a single serve beverage brewer having a first inlet probe for dispensing water above a first cavity and a first outlet probe protruding from a bottom of the cavity and (ii) a multi-serving beverage brewer having a second inlet probe for dispensing water above a second cavity having a height larger than the first cavity and a second outlet probe also positioned above the second cavity. The beverage brewing device includes a base cup including a bottom wall defining at least one outlet probe receptacle protruding inwardly from a lower surface of the bottom wall, the at least one outlet probe receptacle sized and positioned to extend over the first outlet probe when the base cup is inserted in the first cavity. The base cup further includes a base rim defining a base fastening structure and a base opening, the base rim positioned opposite the bottom wall and vertically offset from the bottom wall. The base cup includes a base sidewall extending vertically from the upper rim to the bottom wall and circumferentially around the bottom wall, at least one of the base sidewall and the bottom wall defining one or more filter openings, the one or more filter openings being completely covered in a permeable filter material.

The brewing device further includes a first upper cup portion including a first lower rim defining a first fastening structure and a first lower opening, the first fastening structure configured to engage the base fastening structure effective to seal the first lower rim to the base rim. The first upper cup portion further includes a first upper rim defining a first upper opening sized and positioned to receive the first inlet probe when the first upper cup is secured to the base cup and positioned in the first cavity. The first upper cup portion includes a first sidewall extending vertically between the first lower rim and the first upper rim and defining a completely sealed surface circumferentially around and vertically between the first lower rim and first upper rim.

The brewing device further includes a second upper cup portion including a second lower rim defining a second fastening structure and a second lower opening, the second fastening structure configured to engage the base fastening structure effective to seal the second lower rim to the base rim. The second upper cup portion further includes a second upper rim defining a first upper opening sized and positioned to receive the second inlet probe when the second upper cup is secured to the base cup and positioned in the second cavity. The second upper cup portion further includes a second sidewall extending vertically between the second lower rim and the second upper rim and defining a completely sealed surface circumferentially around and vertically between the second lower rim and second upper rim.

The second upper cup portion defines a second axis of symmetry and the first upper cup portion defines a first axis of symmetry, the second upper cup portion having a greater extent along the second axis of symmetry than an extent of the first upper cup portion along the first axis of symmetry.

In some embodiments, the first upper cup portion and base cup when fastened to one another define a volume sized for brewing of a single serving whereas the second upper cup portion and base cup when fastened to one another define a volume sized for brewing three or more servings.

In some embodiments, the second upper portion includes a tube is fastened along the second sidewall, the tube including an upper opening sized to receive the second outlet probe. The tube may extend downwardly beyond a lowermost edge of the second lower rim such that a bottom opening of the tube is positioned below the lowermost edge of the second lower rim.

In some embodiments, the base cup includes base threads, the first fastening structure includes first threads sized to engage with the base threads and the second fastening structure includes second threads sized to engage with the base threads.

In some embodiments, the outlet probe receptacle is a first outlet probe receptacle and the base cup further defines a second outlet probe receptacle, the first and second outlet probe receptacles being 180 degrees apart. In some embodiments, the outlet probe receptacle defines a continuous imperforated surface.

In some embodiments, the first lid further includes a resilient material and defines a recess on an upper surface of the lid surrounding the first inlet probe aperture, the recess sized to receive a shoulder surrounding the first inlet probe.

In some embodiments, the one or more filter openings occupy between 50 and 80 percent of a vertical circumferential base sidewall. The permeable filter material comprises a mesh comprising at least one of gold, stainless steel, plastic, and fabric.

### BRIEF DESCRIPTION OF THE DRAWINGS

Preferred and alternative examples of the present invention are described in detail below with reference to the following drawings:

FIGS. 1A and 1B are isometric cut-away views of a base cup in accordance with an embodiment of the present invention;

FIG. 2 is an isometric view of a first adapter ring for securing to the base cup in accordance with an embodiment of the present invention;

FIG. 3 is an isometric view of an inlet probe insert for securing to the first adapter ring in accordance with an embodiment of the present invention;

FIG. 4 is a side cross-sectional view of the base cup having the first adapter ring secured thereto positioned within a beverage brewer in accordance with an embodiment of the present invention;

FIG. 5 is an isometric view of a second adapter ring for securing to the base cup in accordance with an embodiment of the present invention;

FIG. 6 is an isometric view of an inlet probe insert for securing to the second adapter ring in accordance with an embodiment of the present invention; and

FIG. 7 is a side cross-sectional view of the base cup having the second adapter ring secured thereto positioned within a different beverage brewer in accordance with an embodiment of the present invention.

### DETAILED DESCRIPTION OF THE PREFERRED EMBODIMENT

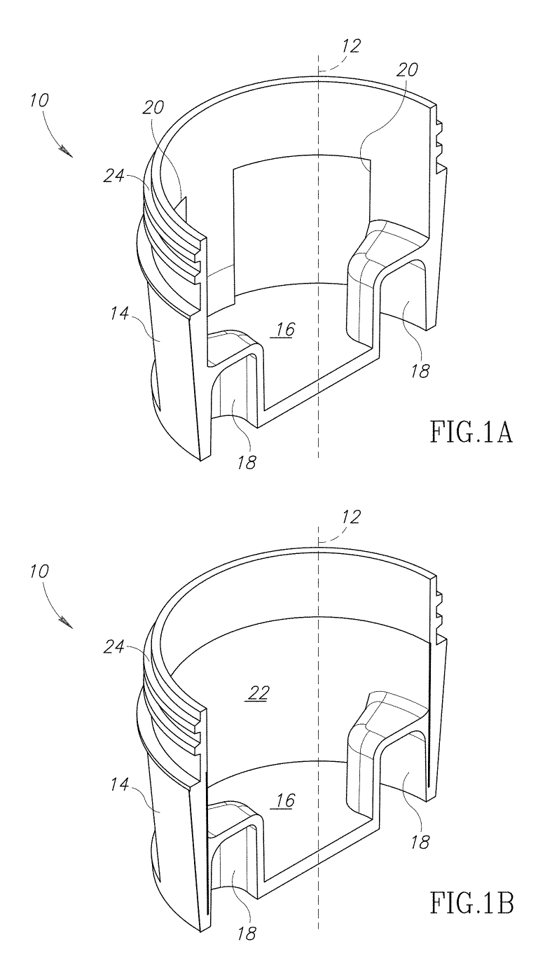

Referring to FIG. 1A, a base cup 10 may be used in combination with one or more adapter rings in order to provide a reusable filter cartridge that can be used with multiple beverage brewers to prepare varying quantities of a brewed beverage.

The base cup 10 may define an axis of symmetry 12 about which a sidewall 14 of the base cup 10 is generally symmetrical with various non-symmetrical features defined thereon. The sidewall 14 has a generally conical shape with a shallow tapering to conform to a cavity of a beverage brewer. A bottom wall 16 extends inwardly from the sidewall 14 such that some or all of the sidewall 14 extends above an upper surface of the bottom wall 16. One or more outlet probe receptacles 18 protrude inwardly from one or both of the sidewall 14 and the bottom wall 16. In the illustrated embodiment, two outlet probe receptacles 18 protrude upwardly through the bottom wall 16 and are disposed 180 degrees apart about the axis of symmetry 12. The outlet probe receptacles 18 include pockets made of continuous, imperforated, impermeable material (e.g., the same material as the base cup) that isolate the contents of the base cup 10 from an outlet probe protruding into the outlet probe receptacle. In a typical beverage brewer, only one outlet probe is present. However, providing two receptacles 18 enables the user to position the base cup in two positions without interference from the outlet probe.

The sidewall 14 further defines one or more filter apertures 20. The filter apertures 20 may be large and occupy a major portion (e.g., between 50 and 80 percent) of the vertical (e.g., parallel to the axis of symmetry 12) and circumferential (e.g., about the axis of symmetry 12) extent of the sidewall 14 between the topmost and bottommost edges thereof.

Referring to FIG. 1B, the filter apertures 20 are completely covered by filter material 22. Any suitable reusable, durable filter may be used, such as a micro-screen mesh filter made from metal (such as gold or stainless steel, gold-tone filters), plastic, or fabric. The filter material 22 may be molded into the material of the sidewall 14 in order to resist separation from the sidewall 14 after repeated use.

An upper rim of the sidewall 14 includes a fastening structure such as threads 24, a snap-type fitting, or any other type of fastening structure. The filter apertures 20 are positioned between the threads 24 and the bottom wall 16 such that a seal may be created between the threads 24 and an adapter ring secured thereto.

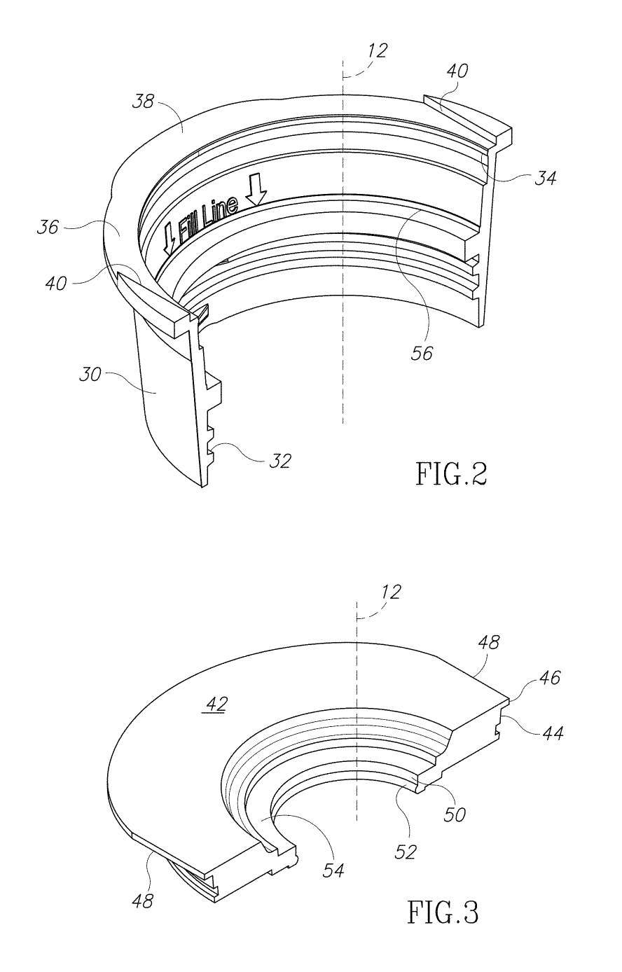

Referring to FIG. 2, an adapter ring 30 may fasten to the base cup 10 such that together they form a cup sized to fit within a cavity of a beverage brewer that is sized to receive a particular type of disposable cartridge. In the illustrated embodiment, the adapter ring 30 is a continuous impermeable ring without apertures covered in filtering material. In some embodiments, openings covered in filtering material may be included in the adapter ring 30. The adapter ring 30 may have a generally conical shape having a taper matching that of the sidewall 14 of the base cup 10 or being different therefrom. The adapter ring 30 includes fastening structures at its lower rim for securing to the base cup 10. In the illustrated embodiment, threads 32 are defined on an inner surface of the adapter ring 30 and are sized to engaged the threads 24 of the base cup 10 and create a seal.

An inner rim 34 may be defined on the ring 30 offset from the threads 32 along the axis of symmetry 12. The rim 34 may include threads or a continuous ridge or groove for receiving an insert (see FIG. 3). An outer rim 36 may protrude outwardly from, or near, the upper edge of the ring 30, the upper edge of the ring 30 being the edge furthest from the threads 32 along the axis of symmetry 12. The outer rim 36 may be sized to seat within a seating groove of a beverage brewer as described below. The outer rim 36 may include one or more tabs 38 that project outwardly form the remaining portions of the rim 36 in order to facilitate alignment. For example, the tabs 38 may be aligned with the outlet probe receptacles of the base cup 10 when the base cup 10 is fastened to the adapter ring 30. The outer rim 36 may define flattened, inward-facing shoulders 40 that project upwardly from the rim 36 parallel to the axis of symmetry 12.

Referring to FIG. 3, an insert 42 is positioned within the upper portion of the adapter ring 30 and defines a circumferential surface 44 sized to engage with the inner rim 34 of the adapter ring 30 thereby creating a seal. The insert 42 may be formed of a resilient polymer such that it may deform to permit insertion into the inner rim 34. The insert 42 may include an outer rim 46 that projects outwardly from the surface 44 and rests on an upward facing surface (e.g., facing parallel to the axis of symmetry 12) of the adapter ring 30 when engaged with the groove 44 is engaged with the inner rim 34. The outer rim 46 may be circular about the axis of symmetry 12 except for flattened 48 portions that are sized and positioned to engage with the shoulders 44 when the groove 44 is engaged with the inner rim 34.

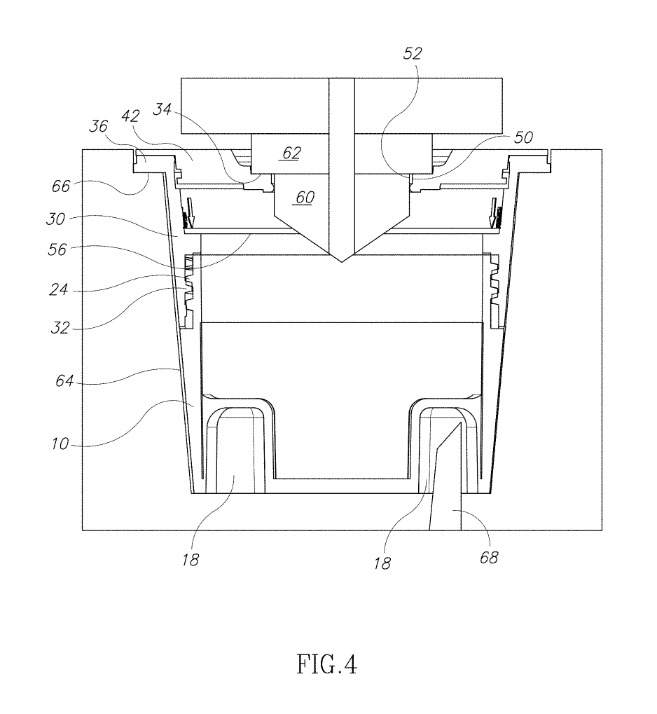

The insert 42 further defines an inlet probe aperture 50 sized to receive an inlet probe of a beverage brewer. The insert 42 may include a sealing ring 52 projecting inwardly into the inlet probe aperture 50 in order to create a seal between itself and the inlet probe. Accordingly, the inner diameter of the sealing ring 52 may be smaller than that of the inlet probe such that elastic deformation of the sealing ring 52 is required to insert the inlet probe. An upper surface of the insert 42 may further include a recessed seat 54 surrounding the inlet probe aperture 50 and providing a surface for engaging a shoulder surrounding the inlet probe of a beverage brewer in order to create a seal. The spacer ring 30 may include a line, text, circumferential rib, or other structure 56 (see FIG. 4) instructing a user as to the proper fill level. The level of the brewing medium within the spacer ring 30 and base cup 10 combination is preferably such that it does not contact the inlet probe of a beverage brewer when inserted within the inlet probe aperture 50 or otherwise is appropriate for the amount of a beverage to be brewed.

FIG. 4 illustrates the base cup 10 secured to the adapter ring 30 and having the insert 42 engaged with the inner rim 34 of the adapter ring 30. FIG. 4 further shows an inlet probe 60 inserted within the inlet probe aperture 50. A shoulder 62 or seal 62 made of a flexible polymer material surrounds the inlet probe 60 and engages the recessed seat 54 thereby promoting a seal. Likewise, the sealing ring 52 contacts the inlet probe and further promotes sealing.

The base cup 10 and the adapter ring 30 are secured to one another by means of the engagement of the threads 24 of the base cup 10 with the threads 32 of the adapter ring 30. The base cup 10 and some or all of the adapter ring 30 sit within a cavity 64 having a size and shape conforming to the size and shape of the base cup 10 and any portion of the adapter ring 30 positioned therein. The cavity 64 may include a rim seat 66 that is sized to receive the outer rim 36 of the adapter ring 30, such as a countersunk portion 66 of a conical-shaped cavity 64 sized to receive the base cup 10 and adapter ring 30.

An outlet probe 68 protrudes into the cavity from a lower surface thereof and is positioned within one of the outlet probe receptacles 18. In a typical beverage brewer, there is a single outlet probe 68. Accordingly, the base cup may be rotated 180 degrees and still provide clearance for the outlet probe 68 in embodiments having two outlet probe receptacles 18.

The base cup 10 and at least a portion of the volume within the spacer ring 30 is filled with a brewing medium such as coffee, tea, cocoa, or any other herb or substance that may be used to infuse water. In use, the amount of the brewing medium does not rise above the fill indicating structure 56, such as the “Fill Line” shown in FIG. 3.

After the base cup 10 and spacer ring 30 combination is placed in the cavity 64 and the inlet probe 60 and shoulder 62 are engaged with the insert 42 as shown in FIG. 4, hot water is dispensed through the inlet probe 60, passes through the brewing medium, passes out through the filter material 22, and is drawn out through the outlet probe 68. The beverage brewer then directs the water drawn into the outlet probe 68 into a cup or carafe in the conventional manner.

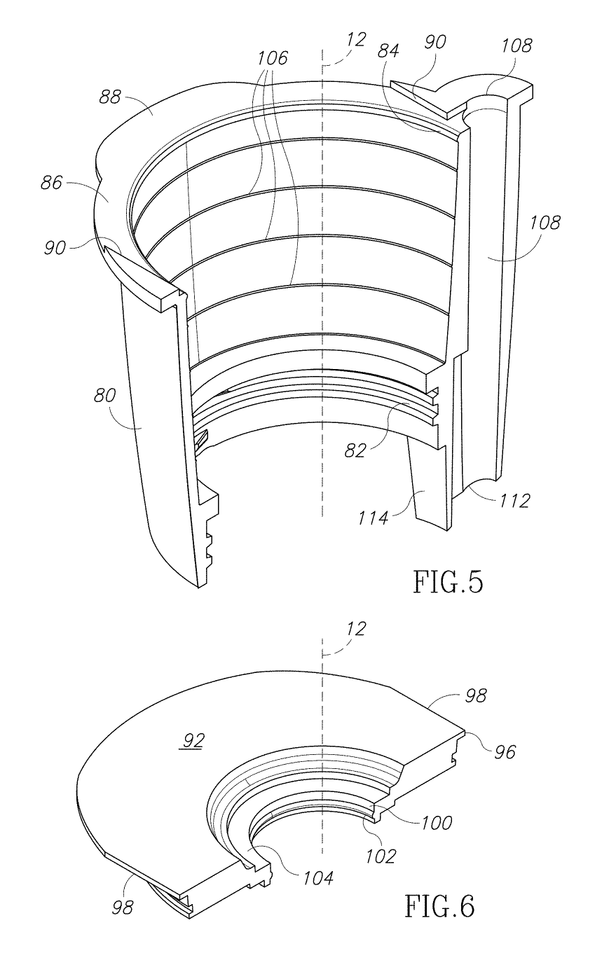

Referring to FIG. 5, an adapter ring 80 may fasten to the base cup 10 such that together they form a cup sized to fit within a cavity of a beverage brewer that is sized to receive a particular type of disposable cartridge. In the illustrated embodiment, the adapter ring 80 is a continuous impermeable ring without apertures covered in filtering material. In some embodiments, openings covered in filtering material may be included in the adapter ring 80. The adapter ring 80 may have a generally conical shape having a taper matching that of the sidewall 14 of the base cup 10 or being different therefrom. As is apparent in FIG. 5, the adapter ring 80 has a much greater extent parallel to the axis of symmetry 12 and is suitable for brewing multiple servings of a brewed beverage using a beverage brewer having a cavity sized to receive a much larger cartridge than the adapter 30 and base cup 10 combination. The adapter ring 80 includes fastening structures at its lower rim for securing to the base cup 10. In particular, the adapter ring 80 includes fastening structures to secure to the exact same base cup 10 as can secure to the adapter ring 30 as described above. In the illustrated embodiment, threads 82 are defined on an inner surface of the adapter ring 80 and are sized to engaged the threads 24 of the base cup 10 and create a seal.

An inner rim 84 may be defined on the ring 80 offset from the threads 82 along the axis of symmetry 12. The rim 84 may include threads or a continuous ridge or groove for receiving an insert (see FIG. 6). An outer rim 86 may protrude outwardly from, or near, the upper edge of the ring 80, the upper edge of the ring 80 being the edge furthest from the threads 82 along the axis of symmetry 12. The outer rim 86 may be sized to seat within a seating groove of a beverage brewer as described below. The outer rim 86 may include one or more tabs 88 that project outwardly form the remaining portions of the rim 86 in order to facilitate alignment. The outer rim 86 may define flattened, inward-facing shoulders 90 that project upwardly from the rim 86 parallel to the axis of symmetry 12.

Referring to FIG. 6, an insert 92 is positioned within the upper portion of the adapter ring 80 and defines a circumferential surface 94 sized to engage with the inner rim 84 of the adapter ring 80 thereby creating a seal. The insert 92 may be identical to the insert 42 or may be different. For example, the insert 92 may have a larger diameter but otherwise have the same structural features as the insert 42.

The insert 92 may be formed of a resilient polymer such that it may deform to permit insertion into the inner rim 84. The insert 92 may include an outer rim 96 that projects outwardly from the surface 94 and rests on an upward facing surface (e.g., facing parallel to the axis of symmetry 12) of the adapter ring 80 when engaged with the groove 44 is engaged with the inner rim 84. The outer rim 96 may be circular about the axis of symmetry 12 except for flattened portions 98 that are sized and positioned to engage with the shoulders 90 when the groove 94 is engaged with the inner rim 84.

The insert 92 further defines an inlet probe aperture 100 sized to receive an inlet probe of a beverage brewer. The insert 92 may include a sealing ring 102 projecting inwardly into the inlet probe aperture 100 in order to create a seal between itself and the inlet probe. Accordingly, the inner diameter of the sealing ring 102 may be smaller than that of the inlet probe such that elastic deformation of the sealing ring 102 is required to insert the inlet probe. An upper surface of the insert 92 may further include a recessed seat 104 surrounding the inlet probe aperture 100 and providing a surface for engaging a shoulder surrounding the inlet probe of a beverage brewer in order to create a seal.

Referring again to FIG. 5, the spacer ring 80 may include one or more a lines, ribs, or other structures 106 instructing a user as to the proper fill level. Inasmuch as the combined spacer ring 80 and base cup 10 enable the preparation of multiple servings, various lines 106 may be provided within the ring 80 each corresponding to a different number of servings. The level of the brewing medium within the spacer ring 80 and base cup 10 combination is preferably such that it does not contact the inlet probe inserted through the inlet probe opening 100 of a beverage brewer or otherwise is appropriate for the amount of a beverage to be brewed.

The spacer ring 80 may be different from the spacer ring 30 in that a tube 108 extends along the outer surface of the spacer ring 80. The tube 108 may be monolithically formed (e.g. co-molded) with the spacer ring 80 or secured thereto. An upper opening 110 of the tube 108 may be flush with an upper edge of the shoulders 90 and may be 90 degrees offset from the tabs 88 about the axis of symmetry 12.

A lower opening 112 of the tube 108 may be positioned at or below the lowermost edge of the spacer ring 80. In the illustrated embodiment, an extension 114 extends below the lower edge of the spacer ring 80 and the lower opening 112 is defined by a lowermost surface of the extension 114. As is apparent in FIG. 5, the cross-section of the tube 108 within the extension 114 (perpendicular to the axis of symmetry 12) changes above the lowermost edge of the spacer ring 80 down to the lower opening 112 of the tube 108. In particular, the cross-section becomes larger due to increased space between the tube and the inner wall of the spacer ring 80 due to the tapered shape of the spacer ring. In this manner, resistance to fluid flow is reduced.

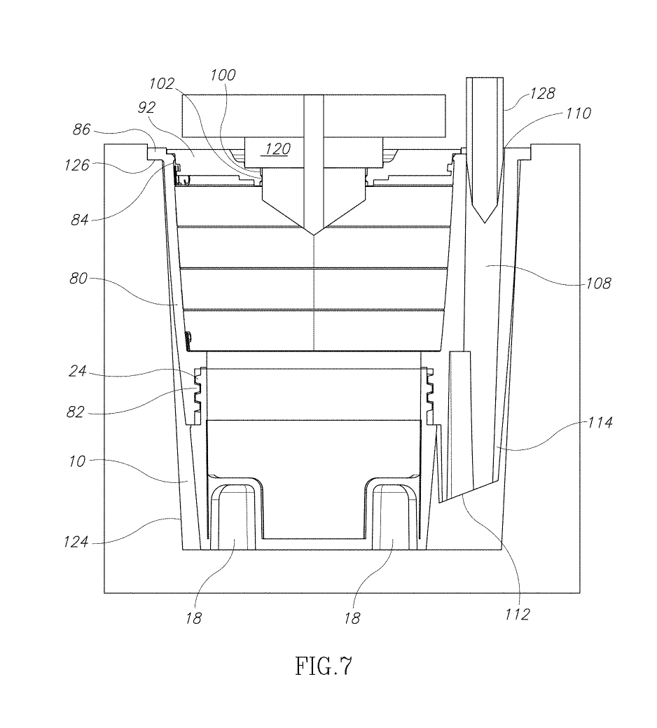

FIG. 7 illustrates the base cup 10 secured to the adapter ring 80 and having the insert 92 engaged with the inner rim 84 of the adapter ring 80. FIG. 7 further shows an inlet probe 120 inserted within the inlet probe aperture 100. A shoulder 122 or seal 122 made of a flexible polymer material surrounds the inlet probe 120 and engages the recessed seat 104 thereby promoting a seal. Likewise, the sealing ring 102 contacts the inlet probe 120 and further promotes sealing.

The base cup 10 and the adapter ring 80 are secured to one another by means of the engagement of the threads 24 of the base cup 10 with the threads 82 of the adapter ring 80. The base cup 10 and some or all of the adapter ring 80 sit within a cavity 124 having a size and shape conforming to the size and shape of the base cup 10 and any portion of the adapter ring 80 positioned in the cavity 124. The cavity 124 may include a rim seat 126 that is sized to receive the outer rim 86 of the adapter ring 80, such as a countersunk portion 126 of a conical-shaped cavity 124 sized to receive the base cup 10 and adapter ring 80.

An outlet probe 128 protrudes downwardly from above the cavity 124 and is positioned relative to the inlet probe 120 such that the outlet probe 128 extends into the upper opening 110 of the tube 108 when the inlet probe 120 is positioned within the inlet probe aperture 100 of the insert 92. Note that the outlet probe 128 does not extend into either outlet probe receptacle 18, which are not of use with the type of beverage brewer shown in FIG. 7.

The base cup 10 and at least a portion of the volume within the spacer ring 80 is filled with a brewing medium such as coffee, tea, cocoa, or any other herb or substance that may be used to infuse water. After the base cup 10 and spacer ring 80 combination is placed in the cavity 124 and the inlet probe 120 and shoulder 122 are engaged with the insert 92 and the outlet probe 128 is inserted within the tube 108 as shown in FIG. 7, hot water is dispensed through the inlet probe 120, passes through the brewing medium, passes out through the filter material 22, and is drawn out through the outlet probe 128. The beverage brewer then directs the water drawn into the outlet probe 128 into a cup or carafe in the conventional manner. In the illustrated embodiment, a seal may exist between the walls of the spacer ring 80 and/or base cup 10 and the walls of the cavity 124 such that suction applied through the tube 108 may draw liquid out of the cavity 124, rather than simply drawing in ambient air. Additionally or alternatively, the cavity 124 itself may be sealed by a cover included in the beverage brewer such that suction applied through the tube 108 will be effective to draw infused liquid within the cavity 124 notwithstanding the fact that the bottom opening 112 is not at the bottom of the cavity or connected to the volume enclosed by the base cup 10.

In use, the base cup 10 and spacer rings 30, 80 may be sold and stored as a kit. A user may then secure one spacer ring 30, 80 to the base cup 10, use it as described above to brew a beverage. The user may then secure the other spacer ring 80, 30 to the base cup 10 and use it as described above. A single product is therefore able to hold a brewing medium and perform filtering for multiple types of beverage brewers and for single serve use as well as multiple serving use. Although only two spacer rings 30, 80 are disclosed herein, other numbers and configurations of spacer rings 30, 80 may be used to accommodate still more types of beverage brewers.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1-10. (canceled)

11. A beverage brewing device for use with both (i) a multi-serving beverage brewer having a first inlet probe for dispensing water above a first cavity and a first outlet probe positioned above the second cavity and (ii) a single serve beverage brewer having a second inlet probe for dispensing water above a second cavity having a height smaller than the first cavity and a second outlet probe protruding from a bottom of the second cavity, comprising:
a base cup including
a bottom wall defining at least one outlet probe receptacle protruding inwardly from a lower surface of the bottom wall, the at least one outlet probe receptacle sized and positioned to extend over the first outlet probe when the base cup is inserted in the first cavity;
a base rim defining a base fastening structure and a base opening, the base rim positioned opposite the bottom wall and vertically offset from the bottom wall; and
a base sidewall defining a base inner surface extending vertically from the base rim to the bottom wall and circumferentially around the bottom wall, at least one of the base sidewall and the bottom wall defining one or more filter openings, the one or more filter openings being completely covered in a permeable filter material; and
a first upper cup portion including
a first lower rim defining a first fastening structure and a first lower opening, the first fastening structure engaging the base fastening structure effective to seal the first lower rim to the base rim;
a first upper rim defining a first upper opening;
a lid removably secured to the first upper rim, the lid defining an inlet probe opening sized and positioned to receive the first inlet probe when the first upper cup is secured to the base cup and positioned in the first cavity; and
a first sidewall having a first inner surface extending vertically between the second lower rim and the second upper rim and defining a completely sealed surface circumferentially around and vertically between the second lower rim and second upper rim, the first inner surface abutting the base inner surface such that the first inner surface, base inner surface, lid and bottom wall define a volume for receiving brewing material.

12. The beverage brewing device of claim 11, wherein
the first upper cup portion and base cup when fastened to one another define a volume sized for brewing of a multiple servings.

13. The beverage brewing device of claim 11, wherein the first upper portion includes a tube fastened along the first sidewall, the tube including an upper opening sized to receive the first outlet probe.

14. The beverage brewing device of claim 13, wherein the tube extends downwardly beyond a lowermost edge of the first lower rim such that a bottom opening of the tube is positioned below the lowermost edge of the first lower rim.

15. The beverage brewing device of claim 11, wherein the base cup includes base threads and the first fastening structure includes first threads sized to engage with the base.

16. The beverage brewing device of claim 11, wherein the at least one outlet probe receptacle is a first outlet probe receptacle, the base cup further defining a second outlet probe receptacle, the first and second outlet probe receptacles being 180 degrees apart.

17. The beverage brewing device of claim 11, wherein the at least one outlet probe receptacle defines a continuous imperforated surface.

18. The beverage brewing device of claim 11, wherein the lid further comprises a resilient material and defines a recess on an upper surface of the lid surrounding the first inlet probe aperture, the recess sized to receive a shoulder surrounding the first inlet probe.

19. The beverage brewing device of claim 11, wherein the one or more filter openings occupy between 50 and 80 percent of a vertical and circumferential extent of the base sidewall.

20. The beverage brewing device of claim 11, wherein the permeable filter material comprises a mesh comprising at least one of gold, stainless steel, plastic, and fabric.

21. A kit for use with both (i) a single serve beverage brewer having a first inlet probe for dispensing water above a first cavity and a first outlet probe protruding from a bottom of the cavity and (ii) a multi-serving beverage brewer having a second inlet probe for dispensing water above a second cavity having a height larger than the first cavity and a second outlet probe also positioned above the second cavity, the beverage brewing device comprising:
a base cup including
a bottom wall defining at least one outlet probe receptacle protruding inwardly from a lower surface of the bottom wall, the at least one outlet probe receptacle sized and positioned to extend over the first outlet probe when the base cup is inserted in the first cavity;
a base rim defining a base fastening structure and a base opening, the base rim positioned opposite the bottom wall and vertically offset from the bottom wall; and
a base sidewall defining a base inner surface extending vertically from the base rim to the bottom wall and circumferentially around the bottom wall, at least one of the base sidewall and the bottom wall defining one or more filter openings, the one or more filter openings being completely covered in a permeable filter material;
a first upper cup portion including
a first lower rim defining a first fastening structure and a first lower opening, the first fastening structure configured to engage the base fastening structure effective to seal the first lower rim to the base rim;
a first upper rim defining a first upper opening; and
a first sidewall having a first inner surface extending vertically between the first lower rim and the first upper rim and defining a completely sealed surface circumferentially around and vertically between the first lower rim and first upper rim, the first inner surface adapted to abut the base inner surface when the first fastening structure is engaged with the base rim such that the first inner surface, base inner surface, lid, and bottom wall define a volume for receiving brewing material;
a second upper cup portion including
a second lower rim defining a second fastening structure and a second lower opening, the second fastening structure configured to engage the base fastening structure effective to seal the second lower rim to the base rim;
a second upper rim defining a second upper opening; and
a second sidewall having a second inner surface extending vertically between the second lower rim and the second upper rim and defining a completely sealed surface circumferentially around and vertically between the second lower rim and second upper rim, the second inner surface adapted to abut the base inner surface when the second fastening structure is engaged with the base fastening structure such that the first inner surface, base inner surface, lid, and bottom wall define a volume for receiving brewing material;
at least one lid sized to fit in at least one of the first upper opening and the second upper opening, the at least one lid defining an inlet probe opening sized to receive at least one of the first inlet probe and the second inlet probe;
wherein the second upper cup portion defines a second axis of symmetry and the first upper cup portion defines a first axis of symmetry, the second upper cup portion having a greater extent along the second axis of symmetry than an extent of the first upper cup portion along the first axis of symmetry; and
wherein the base cup includes base threads, the first fastening structure includes first threads sized to engage with the base threads and the second fastening structure includes second threads sized to engage with the base threads.

22. The kit of claim 21, wherein
the first upper cup portion and base cup when fastened to one another define a volume sized for brewing of a single serving; and
the second upper cup portion and base cup when fastened to one another define a volume sized for brewing three or more servings.

23. The kit of claim 21, wherein the second upper portion includes a tube that is fastened along the second sidewall, the tube including an upper opening sized to receive the second outlet probe.

24. The kit of claim 23, wherein the tube extends downwardly beyond a lowermost edge of the second lower rim such that a bottom opening of the tube is positioned below the lowermost edge of the second lower rim.

25. The kit of claim 21, wherein the at least one outlet probe receptacle is a first outlet probe receptacle, the base cup further defining a second outlet probe receptacle, the first and second outlet probe receptacles being 180 degrees apart.

26. The kit of claim 21, wherein the least one outlet probe receptacle defines a continuous imperforated surface.

27. The kit of claim 21, wherein the lid further comprises a resilient material and defines a recess on an upper surface of the lid surrounding the first inlet probe aperture, the recess sized to receive a shoulder surrounding the first inlet probe.

28. The kit of claim 21, wherein the one or more filter openings occupy between 50 and 80 percent of a vertical and circumferential extent of the base sidewall.

29. The kit of claim 21, wherein the permeable filter material comprises a mesh comprising at least one of gold, stainless steel, plastic and fabric.
